(19) United States
(12) Patent Application Publication
(10) Pub. No.: US 2009/0176581 A1
(43) Pub. Date: Jul. 9, 2009

(54) INSTRUCTIONAL GAMING METHODS AND APPARATUS

(75) Inventors: Phineas Ayer Barnes, Portland, OR (US); Ted Spooner, Portland, OR (US); Jade L. Dhabolt, Portland, OR (US); Jason Leighton, West Linn, OR (US)

Correspondence Address: Stolowitz Ford Cowger LLP, 621 SW Morrison St, Suite 600, Portland, OR, 97205, US

(73) Assignee: responDesign, Inc., Portland, OR (US)

(21) Appl. No.: 12/397,513

(22) Filed: Mar. 4, 2009

Related U.S. Application Data
(63) Continuation of application No. 11/038,892, filed on Jan. 18, 2005.
(60) Provisional application No. 60/537,098, filed on Jan. 16, 2004.

(51) Int. Cl. A63F 9/24; A63F 13/00

(52) U.S. Cl. 463/43; 463/30

(57) ABSTRACT

An instructional gaming apparatus and method implements adaptive instructional gaming from a start point along a trajectory to a final goal. The system comprises a receiver for electronically receiving data from a user. The system further includes an electronic subject matter database with a clearly defined set of discrete heuristics combined with an electronic processor for the creation of an electronic instructional gaming curriculum unique to the individual user and their goals to enable proficiency in the given subject matter. Performance is periodically tested. And electronic means allows the information from the user performance database to be incorporated into the discrete heuristic utilized by the electronic processor for the creation of future electronic instructional gaming curriculums and/or individual instructional gaming lessons for the specific user in the given subject.

### CROSS-REFERENCES TO RELATED APPLICATIONS

This invention is a continuation of U.S. patent application Ser. No. 11/038,892, filed Jan. 18, 2005, entitled: Instructional Gaming Methods and Apparatus which claims the benefit of U.S. Provisional Patent Application No. 60/537,098 filed Jan. 16, 2004, and which is herein incorporated by reference in its entirety.

### BACKGROUND OF THE INVENTION

1. Field of the Invention

Tbe invention relates to heuristic learning systems, and more particularly to methods and systems for utilizing graphics systems, such as in game consoles, for generating and tracking workout or instructional parameters for users based on recommended or adjusted goals.

2. Description of the Prior Art

Goal oriented learning, particularly in a fitness environment, has been the environment of live instructors. This presents several disadvantages as the person being instructed must typically be in the physical presence of the instructor. And while videos of instructors, such as in workout tapes, have been popular, instruction is linear and limited in that the workout is always the same and the workout itself is not specifically directed to the person instructed as they make progress over the course of instruction. Additionally, users are often uneducated in the best ways to achieve their goals and thus the instruction they select is often inappropriate or misused.

Accordingly, the need remains for methods for improving the flexibility of virtual instruction to accommodate the goals and performance criteria of the person being instructed as instruction progresses.

### SUMMARY OF THE INVENTION

Instructional Gaming Software combines the power of the game console/personal computer, programmed heuristics capable of generating tailored instructional gaming, and a system of awards and motivations to create a dynamic, game-like learning environment for the user. The instructional gaming software provides a means for acquiring information about the user that is relevant to the curriculum, assists the user in a goal setting process by providing recommended goals in terms of achievement within the given subject matter, allows the user to adjust those goals, generates a personalized lesson plan designed specifically to help them achieve their goals using a set of heuristics, guides the user through the personalized lesson plan, analyzes the user's progress toward their goals over the course of the lesson plan, and adjusts the lesson plan to accommodate the user's progress.

In a preferred embodiment, the user inputs and/or is tested for their current starting characteristics. Based on those characteristics, a game console/computer calculates a suggested goal. In the fitness context, for instance, if the user is a woman who is 5′6″ and 180 lbs, then the computer may suggest a weight goal based on a body mass index table of 150 lbs. The computer includes a set of heuristics programs that allow the computer to generate a learning program—including workout type and schedule—that would help guide the user toward achievement of their fitness goal in a healthy fashion. A path is generated between the two data points of current situation and goal with checkpoints in between. Reevaluation of the path would then be possible based on learning curve and the learning program trajectory altered accordingly. Expectations can be lowered if, for instance, the user's heart rate continues to be high during workouts and shows no improvement. As an example of altered goal-attainment trajectory, the planned workout schedule can be increased and higher intensity workouts can be delayed until the user's progress, indicated by a decrease in their peak heart rate, requires an increase in workout intensity. Similar adjustments can be made to the lesson plan and overall curriculum based on any of the other user inputs and evaluation of said inputs over time.

Biofeedback tools are another aspect of the invention. Body motion technology, as the EyeToy from Sony Corporation, can be incorporated in the invention to assist the computer in commenting on the user's technique in performing the workout. Heart rate monitors are another tool used to measure fitness during any given exercise program. A user wears the device and the heart rate is monitored as the workout progresses. A lower rate, especially when compared historically with other workouts by the same person, is a good indicator of fitness and can be one criterion which can be input into the learning program to plot learning trajectory and accomplishment.

An alternate aspect of the invention is the use of a computer generated body model that is controlled to affect the workout. One method of animation movement of the computer generated instructor would be to use keyframe animation. The game engine would then transition between keyframes of different workout blocks, i.e. between a standing exercise and a sitting exercise. During testing, the body model can include highlighted portions to show the areas being tested to the user. The user would be able to select the representation of the body model performing an action that is most similar to the way they look while performing said action from multiple representations of the body model performing said action. This allows the user to input accurate information about their physical state to the computer in a simple and intuitive fashion.

The Instructional Gaming Software device configured according to the present invention generates and employs an electronic instructional gaming curriculum. The system comprises a receiver for electronically receiving data from a user. The system further includes an electronic subject matter database with a clearly defined set of discrete heuristics combined with an electronic processor for the creation of an electronic instructional gaming curriculum unique to the individual user and their goals to enable proficiency in the given subject matter. A sensor can be included for detecting at least one user input. A display unit displays instruction and activity information designated by the electronic instructional gaming software in response to a detected status of at least one user characteristic detected by the sensor. An electronic memory storage device creates a user performance database of at least one user performance characteristic detected by the sensor. And electronic means allows the information from the user performance database to be incorporated into the discrete heuristic utilized by the electronic processor for the creation of future electronic instructional gaming curriculums and/or individual instructional gaming lessons for said specific user in the given subject.

Disclosed is an Instructional Gaming Software device that conveniently allows a user to interface with a general or special purpose computing device, such as a Game Console, to adhere to a curriculum designed to increase the said user's proficiency in one or more disciplines.

The electronic Instructional Gaming Software is further adapted to allow the user to define their current level of proficiency within a discipline such as fitness, a sport, dance, foreign language, meal preparation or any other subject through the creation of a personal profile and the completion of specific, pre-defined tests of proficiency in said subject.

Further, the Instructional Gaming Software generates a set of suggested proficiency goals for the user to strive to achieve within said subject matter. The user is able to adjust these computer generated recommended goals to their liking and confirm them as acceptable.

Once the proficiency goals are defined, the Instructional Gaming Software generates a curriculum calendar with a time commitment recommendation. The user has the option to adjust the computer generated calendar and time commitment level to their liking and confirm their choices.

Once this initial set up is complete, the Instructional Gaming Software generates an electronic curriculum designed to guide the user from their current level of proficiency in the chosen subject matter to the specified goal level of proficiency.

Still further, the Instructional Gaming Software utilizes the capability of the general or special purpose computing device to accept user input to detect one or more characteristics of the user's performance during a given instructional session and utilizes the electronic processing capability of said computer device to adjust the current lesson plan to the immediate learning needs and style of said user.

Still further, the Instructional Gaming Software utilizes the storage capability of the general or special purpose computing device to store user results and adjusts the overall electronic curriculum designed for the given user based on past performances of said user to meet the learning needs of said user.

Still further, the Instructional Gaming Software utilizes game psychology and the wealth of information on Artificial Intelligence and Relational Agents to motivate the user through a system of rewards for both consistent time commitment and achievement of both stated proficiency goals and intermediate increases in proficiency identified by the Instructional Gaming Software as illustrating a proper learning trajectory toward the stated proficiency goals of said user.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a block diagram illustrating an apparatus adapted to implement the invention.

FIGS. 2A and 2B are flow diagrams illustrating operation of the instructional gaming concept according to a preferred implementation of the invention.

FIG. 3 is a screen image generated by the instructional gaming system of FIG. 1 showing a home screen menu.

FIG. 4 is a screen image generated by the instructional gaming system of FIG. 1 allowing user input into data fields of user vital statistics.

FIG. 5 is a screen image generated by the instructional gaming system of FIG. 1 used during a fitness evaluation of the user to determine flexibility level.

FIG. 6 is schematic diagram and table showing the construction of a workout curriculum responsive to inputs made into the data fields of FIG. 4 and the performance evaluation such as that shown in FIG. 5.

FIG. 7 is a screen image generated by the instructional gaming system of FIG. 1 showing an exercise tutorial of a particular workout element.

FIG. 8 is a screen image generated by the instructional gaming system of FIG. 1 showing an instructor interface and feedback information.

FIG. 9 is schematic diagram and time-line showing a preferred implementation of the invention operating to construct a workout session from workout blocks stored in a database.

### DETAILED DESCRIPTION

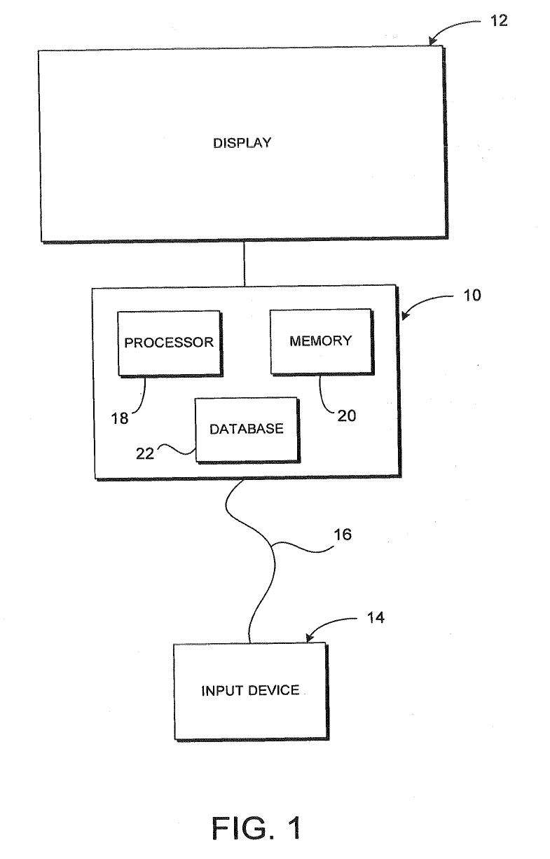

FIG. 1 illustrates an example of a system capable of implementing instructional gaming methods as described herein. The system includes, at a high level, a computer 10 coupled to a display 12 and user operated by way of an input device 14. By way of example, the computer 10 can be a game console such as the X-Box system marketed by Microsoft Corporation with the input device 14 being an X-Box controller and display 12 a television. In this configuration, the X-Box controller 14 would be connected by a cable 16 to the X-Box system 10 and include buttons (not shown) used for scrolling among selectable elements shown on the television display 12. In the alternative, computer 10 can be a personal computer system with the input device being a mouse and/or keyboard and the display a computer screen.

Computer 10 includes a processor 18, memory 20 and database 22. In the X-Box implementation, processor 18 would include a Pentium™-class chip manufactured by Intel in combination with a graphics processor to operate programs stored and running in volatile memory 20. Database 22 includes a non-volatile memory, such as a DVD disc or hard disk drive, in which to store the gaming programs and subroutines used to construct the instructional gaming session as explained in more detail further below.

One would appreciate that the invention is not limited to operation on one type of computer as opposed to another. Input device 14 is used in one implementation of the invention to receive and then communicate to computer 10 user selected inputs responsive to queries generated by the program operable on computer and displayed to the user on display 12. In the alternative, the inputs may be obtained automatically without user selection, as using a biometric device explained further below. Examples of such biometric devices useful in the fitness regime include a heart rate monitor, blood glucose monitor, blood pressure monitor, etc. Furthermore, cable 16 is only representative of the connectivity between input device 14 and computer 10 and is not intended to indicate that it be a wired connection; instead, data can be input or received at input device 14 and then wirelessly transmitted to computer 10.

Although the invention is described primarily in the context of fitness instruction, as to help someone lose weight or improve his/her cardiovascular fitness, the underlying concept is intended to broadly cover the field of instruction with examples of usages shown in Table 1 below.

TABLE 1
Instructional Gaming Subjects

Hobbies/Games: Art History, Card Games, Instrument Instruction,
Woodworking, etc.
Finance: Accounting, Estate Planning, Home Buying, Stock Investing, etc.
College/School Prep: ACT Exam, GED, LSAT Prep., Admission
Essays, etc.
Health/Fitness: Physical Therapy, Fitness, Depression, Yoga, Weight
Loss, etc.
Diet: Being Vegetarian, Dieting, Healing Foods, Nutrition, etc.
Family: Adoption, Divorce, Fertility, Family Tree Making, Potty
Training, etc.
Business/Career: Advertising, Business Plans, Fundraising, Law, etc.
Travel: National Parks, Europe, RV Vacations, etc.
Education: Math, Foreign Language, Chemistry, History, etc.
Cooking/Baking: Appetizers, Baking, Desserts, Grilling, Slow
Cookers, etc.
Pets: Aquariums, Cats, Dog Tricks, Horses, Retired Racing
Greyhounds, etc.
Do It Yourself: Auto Repair, Building Your Own Home, Lawn care, etc.
Sports: Boxing, Golf, Scuba Diving, Fishing, etc.
Religion: The Bible, Islam, Spirituality, etc.

An Instructional Gaming Software device is described that conveniently allows a user to interface with a general or special purpose computing device, such as a Game Console, to adhere to a curriculum designed to increase the said user's proficiency in one or more disciplines.

The electronic Instructional Gaming Software allows the user to define their current level of proficiency within a discipline such as fitness, a sport, dance, foreign language, meal preparation or any other subject through the creation of a personal profile and the completion of specific, pre-defined tests of proficiency in said subject.

Further, the Instructional Gaming Software generates a set of suggested proficiency goals for the user to strive to achieve within said subject matter. The user is able to adjust these computer generated recommended goals to their liking and confirm them as acceptable.

Once the proficiency goals are defined, the Instructional Gaming Software generates a curriculum calendar with a time commitment recommendation. The user has the option to adjust the computer generated calendar and time commitment level to their liking and confirm their choices.

Once this initial set up is complete, the Instructional Gaming Software generates an electronic curriculum designed to guide the user from their current level of proficiency in the chosen subject matter to the specified goal level of proficiency.

Still further, the Instructional Gaming Software utilizes the capability of the general or special purpose computing device 10 to accept user input 14 to detect one or more characteristics of the user's performance during a given instructional session and utilizes the electronic processing capability 18 of said computing device to adjust the current lesson plan to the immediate learning needs of said user.

Still further, the Instructional Gaming Software utilizes the storage capability 22 of the general or special purpose computing device to store user results and adjusts the overall electronic curriculum designed for the given user based on past performance of said user to meet the learning needs of said user.

Still further, the Instructional Gaming Software utilizes game psychology to motivate the user through a system of rewards for both consistent time commitment and achievement of both stated proficiency goals and intermediate increases in proficiency identified by the Instructional Gaming Software as illustrating a proper learning trajectory toward the stated proficiency goals of said user.

The instructional gaming system implemented according to the present invention has several phases. In a first phase, the user is evaluated in the field for which the instructional gaming system is being used. In a fitness context, the user is run through a series of exercises to determine the user's fitness levels. In a learning context, say with a foreign language, the user is tested to determine his or her proficiency in the particular subject, say with vocabulary, conversation, and cultural proficiency. After the initial evaluation, the software heuristics of the system determine a recommended goal for the user based on the user's performance during the evaluation phase. In the fitness context, for instance, should a user perform poorly in the cardio evaluation, have poor flexibility, or have a body mass index (BMI) over the ideal number, the software would recommend goals to address those deficiencies. In the foreign language context, on the other hand, good conversational skills but poor vocabulary may result in a recommendation of further vocabulary work.

The user in a third phase would change or supplement the instructional gaming system recommendation. In the fitness context, the system might recommend a cardio increase long term goal however the user might be instead interested in weight loss. The curriculum created to achieve the goal, and a trajectory for attainment (both concepts discussed further below), would be modified to accommodate the user's selection.

The curricular would then be generated using the heuristics programmed into the instructional gaming system. A trajectory would be calculated, say attainment of a goal of losing 20 pounds in six months or learning 500 vocabulary words in the same amount of time, using various instructional blocks arranged to address those goals. Sample fitness workout blocks would be cardio blocks intended to increase aerobic fitness, upper/lower body strength blocks, core body strength blocks, flexibility blocks, and compound blocks.

The user would then perform the curriculum as time permits and the system would periodically query the user for feedback during or after block performance, session performance, or at other times during use of the instructional gaming system. The curriculum and/or trajectory may be altered depending upon responses received. For instance, feedback that a certain cardio block was too difficult for the user may result in selection and implementation of a lower level cardio block for the next workout session.

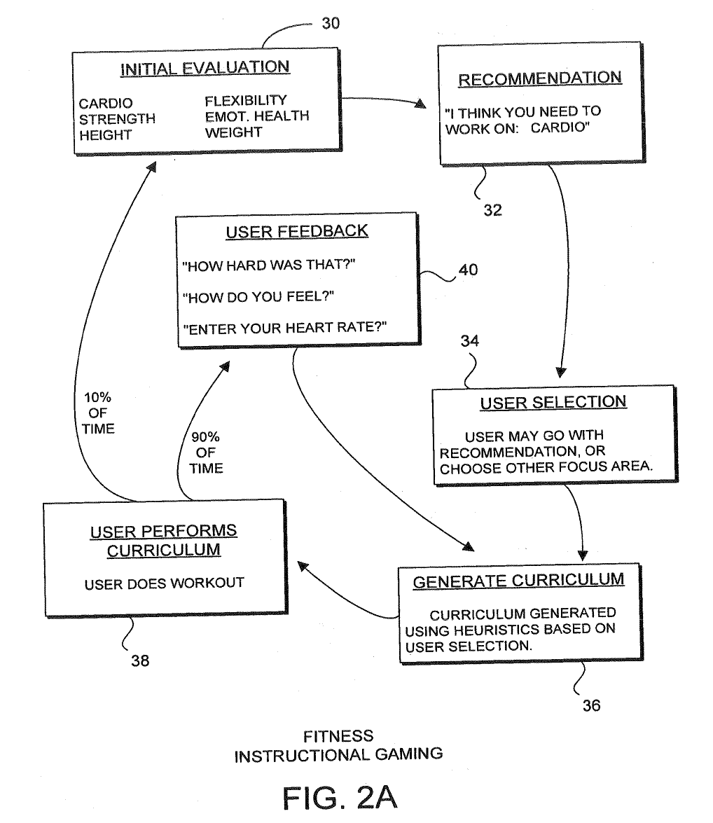

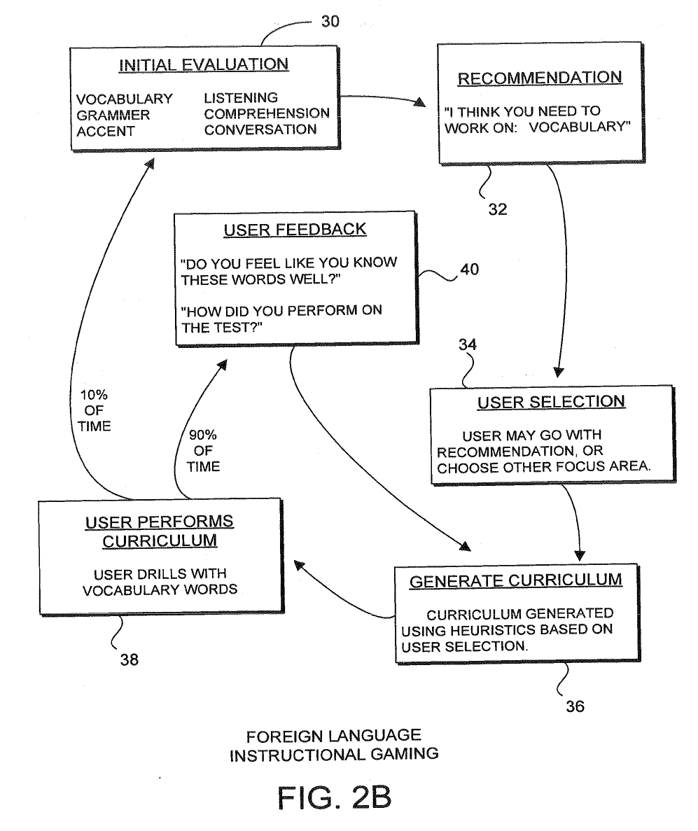

FIG. 2A shows an example of a flow diagram used to operate instructional gaming in the fitness context. The need for such a system in the fitness context is great. Overweight and obese Americans now make up more than 60% of the adult population, and this percentage is growing. Obesity and heaviness are linked to the nation's number one killer, heart disease, as well as diabetes, hypertension and many other chronic and deadly conditions. Today, 300,000 Americans die prematurely each year due to heaviness and inactivity, second only to tobacco-related deaths.

Fifty million households in North America and over 100 million households worldwide have game consoles which so far are used predominately for entertainment gaming. With 20 million video fitness products sold per year (50% of those being DVD), 80% of which are sold to women, the need is great for a product like that described herein.

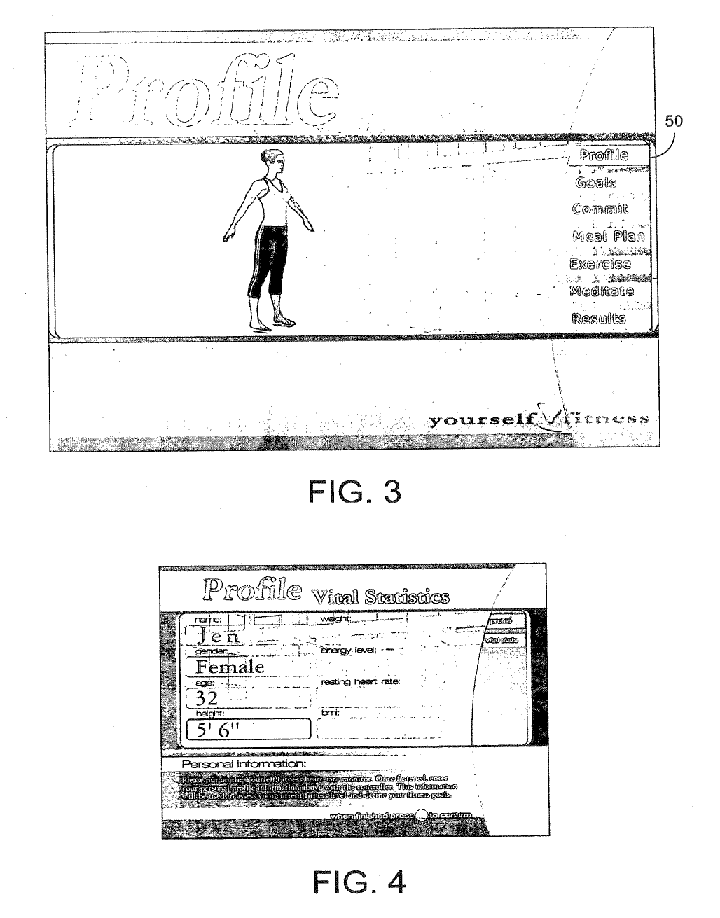

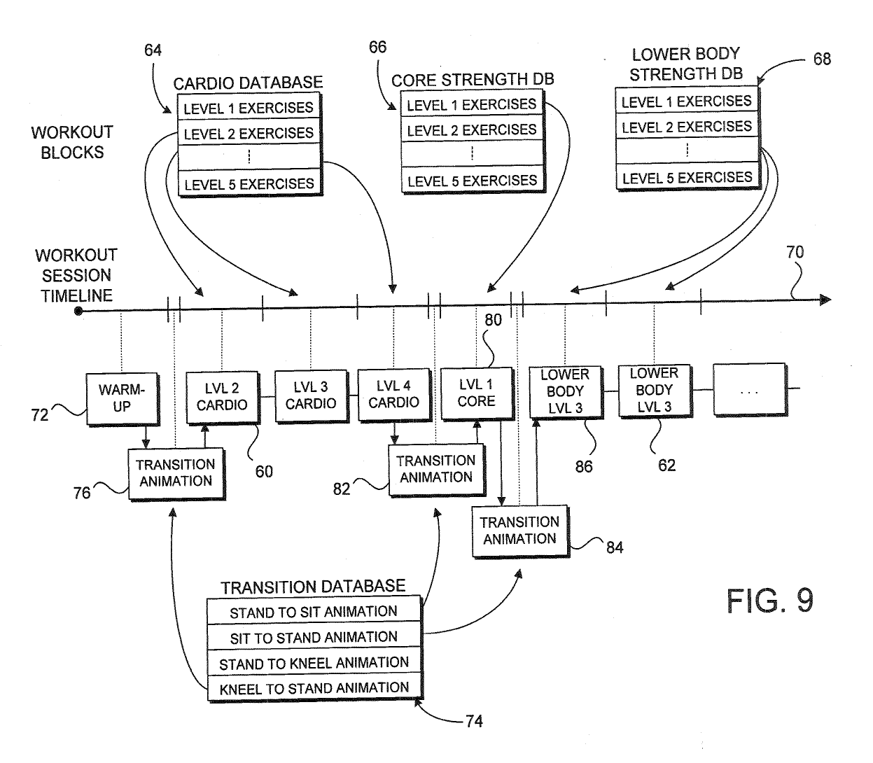

Turning to FIG. 2A, a new user of the instructional gaming system would complete an initial evaluation screen step shown in block 30. A graphic user interface screen would be shown on display 12 allowing a user to scroll through choices shown on such screen. FIG. 3 illustrates an example of such a screen. During the initial evaluation, a user would scroll to and then select the profile button 50 using the input device 14 of the instructional gaming system. A profile screen such as shown in FIG. 4 is then displayed and includes data fields for entry of vital statistics such as height, weight, resting heart rate, etc. The software operable on computer 10 (FIG. 1) queries the user using a battery of physical and/or mental tests. The software first determines which areas of interest the user is most deficient in by instructing the user via the display 12 to perform certain exercises and to relay their performance of those exercises via the input device 14. For instance, the user is asked to perform pushups and to enter the total number performed in a query field (not shown) displayed on display 12 using the input device 14. Such an exercise would test the upper body strength of the user; few pushups would indicate low upper body strength and thus a potential target for future work. When constructing the workout routines (see, e.g., discussion connected to FIG. 9 below), the software heuristic uses this initial evaluation to select the skill/fitness level exercise block appropriate to that user. The system, in other words, would not select a high-level upper body strength workout block until the system receives inputs that the user would be capable of performing the exercises included within that block. Failure to accommodate the user's current fitness level would simply discourage the user from continuing with the workout program.

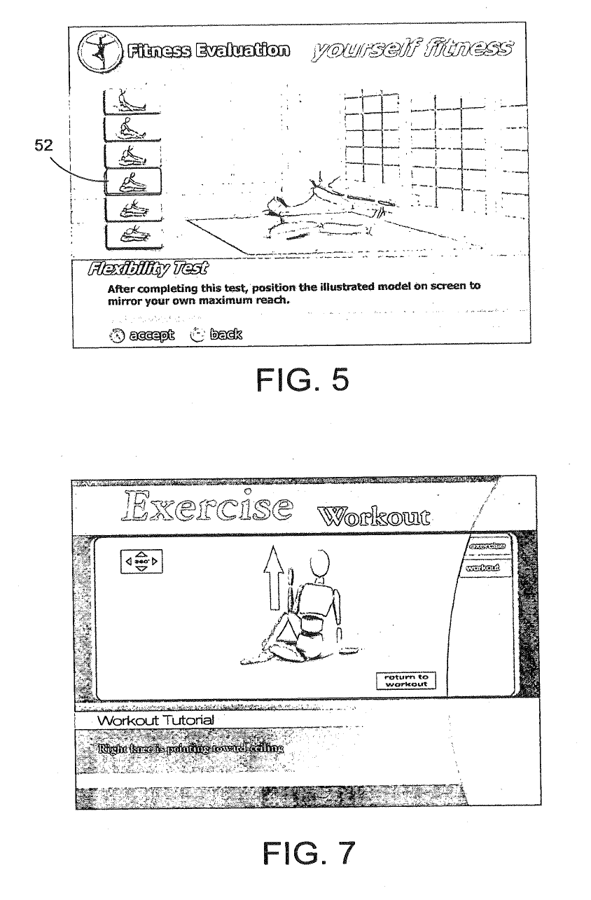

FIG. 5 illustrates a fitness evaluation screen image comprising a flexibility test. In one exercise, the user would be instructed to perform a full-body fold in a pike position. The user would then be presented with a series of pictures or graphics, such as image 52, showing persons in such a position but with different angles of bending. The user would select the picture that be represents their performance of the stretching skill. An open angle would indicate low flexibility while a deep bend would indicate better user flexibility.

Finally, for cardio fitness the user is asked to perform a short routine with the user providing feedback during and/or after the routine is complete. Feedback can take the form of manual feedback, e.g. the user rates their exhaustion level following prompts by the computer system 10 on the display 12 or takes their pulse and inputs the amount via the input device 14. The user would use the input device 14 to enter their perceived exertion level from “Tired” to “O.K.” to “Feeling Great.” Feedback could also be automatic, e.g. via a biometric device such as a heart rate monitor in wired or wireless communication with the computer system 10 to transmit real time heart rate. More generally, the biometric devices would automatically measure performance and communicate such to the computer system 10.

Other evaluations would include emotional health, asking a series of probing questions intended to solicit the psychological balance, or emotional well-being, of the user. There would also be input of objective criteria such as height and weight to determine a user's body mass index (BMI). The BMI is used to determine according to a stable stored in the database 22 whether the user is overweight and perhaps in need of weight loss in addition to fitness improvement. A high BMI may result in a workout program being constructed that includes more workout blocks intended to burn calories and thus help the user lose weight, rather than those blocks used to increase strength or flexibility.

Further details on these evaluations are shown below. The results of these tests are used to track and display the users' progress over time. A typical user of the program may see progress after 3-4 weeks.

Flexibility Test

Goal: Establish the user's flexibility level

Method: Sit and reach (FIG. 5)
Flexibility test: The user first warms up by performing slow stretching movements before taking actual measurements. With bare feet, she sits with their legs fully extended. Keeping the knees fully extended, arms evenly stretched, palms down, the subject bends at the waist and reaches forward (without jerking) as far as she can—past the toes if possible. Lowering the head will maximize the distance reached. The position of maximum flexion must be held for approximately two seconds. The test is repeated twice. If the knees flex, the trial is not counted. DO NOT ATTEMPT TO HOLD KNEES DOWN. The user should not attempt this test if bothered by low back pain or other ailments. (Adapted from: Golding, et al.; Myers, C. R., & Sinning, W. E (Eds.), The Y's Way to Physical Fitness (Revised)

TABLE 2
Flexibility Test Evaluation

| | Age (Years) | | | | | |
|---|---|---|---|---|---|---|
| | 35 and | | | | | |
| | Younger | | 36-45 | | 46 and Older | |
| Rating | Males | Females | Males | Females | Males | Females |
| Excellent | 21 | 23 | 22 | 23 | 20 | 22 |
| Good | 19 | 21 | 19 | 21 | 17 | 19 |
| Above Average | 17 | 20 | 16 | 19 | 15 | 18 |
| Average | 15 | 18 | 14 | 17 | 13 | 15 |
| Below Average | 12 | 15 | 12 | 14 | 11 | 14 |
| Fair | 9 | 14 | 10 | 12 | 8 | 11 |
| Poor | 7 | 11 | 5 | 10 | 5 | 9 |

In an exemplary flexibility test, a user is presented with pictorial representations of a virtual body in various stretching positions and must select the position which best represents how far the user is able to stretch into a particular position. For instance, in a pike sitting position the goal is to be flexible enough so that the user presents a flat back and whose stomach is closely aligned with the top of the thighs. The body would make an angle with the legs that is 30 degrees or less. Less flexible persons might be only able to obtain an 80 degree angle. The display monitor shows pictures or icons showing the pike stretch position at a 90 degree angle, an 80 degree angle, a 70 degree angle and so forth. Rather than guess at the angle, the user can simple select the picture that best represents their position.

Upper Body Strength Test

Goal: Establish the user's upper body strength

Method: Push-up
Upper body strength test: The purpose of the push-up test is to evaluate muscular strength and endurance. User will have the choice to perform either standard or bent-knee push up (both require hands at shoulder width apart). The push-up is complete when the user's chest comes about fist distance from the floor and returns to the start position with arms fully extended. User should exhale when pushing up and inhale while lowering them self to the floor. User should continue performing push-ups until muscle fatigue makes it impossible to continue. Rest is allowed in the UP position only. The user should keep count of how many push-ups she is able to complete.

TABLE 3
Upper Body Strength Evaluation
Push-up Norms for Men and Women by Age Groups Using Number Completed

| | Age Years | | | | | | | | | | | |
|---|---|---|---|---|---|---|---|---|---|---|---|---|
| | 15-19 | | 20-29 | | 30-39 | | 40-49 | | 50-59 | | 60-69 | |
| | M | F | M | F | M | F | M | F | M | F | M | F |
| Excellent | >39 | >33 | >36 | >30 | >30 | >27 | >22 | >24 | >21 | >21 | >18 | >17 |
| Above | 29-38 | 25-32 | 29-35 | 21-29 | 22-29 | 20-26 | 17-21 | 15-23 | 13-20 | 11-20 | 11-17 | 12-16 |
| Average | | | | | | | | | | | | |
| Average | 23-28 | 18-24 | 22-28 | 15-20 | 17-21 | 13-19 | 13-16 | 11-14 | 10-12 | 7-10 | 8-10 | 5-11 |
| Below | 18-22 | 12-17 | 17-21 | 10-14 | 12-16 | 8-12 | 10-12 | 5-10 | 7-9 | 2-6 | 5-7 | 1-4 |
| Average | | | | | | | | | | | | |
| Poor | <17 | <11 | <16 | <9 | <11 | <7 | <9 | <4 | <6 | <1 | <4 | <1 |

Source: CSTF Operations Manual. (3^{rd} ed.) Ottawa, Fitness and Amateur Sport, 1986. The Canadian Standardized Test of Fitness was developed by, and is reproduced with the permission of, Fitness Canada, Government of Canada.

Core Body Strength Test

Goal: Establish the user's core body strength

Method: Sit-up
Core strength test (Bent-knee sit-up): For this particular test, the user follows along as an onscreen figure performs sit-ups at a cadence of 40 bpm. The objective is to determine how many sit-ups can be completed at a set cadence without time constraints. The user should be warmed up before taking the test.
   The user should assume a lying position with feet flat on the floor and knees bent at about 90 degrees. She should place her hands palms-down at their sides.
   When ready, the user slowly flattens their lower back and curls their upper spine.
   User then returns to the original position.
   The user performs as many sit-ups as possible without stopping.
   The test is terminated if the cadence is broken.

TABLE 4
Core Strength Evaluation
Sit-up Standards Using Number Completed

| | Men/Age | | | Women/Age | | |
|---|---|---|---|---|---|---|
| Category | <35 | 35-44 | 45 | <35 | 35-44 | 45 |
| Excellent | 60 | 50 | 40 | 50 | 52 | 30 |
| Good | 45 | 40 | 25 | 40 | 40 | 15 |
| Marginal | 30 | 25 | 15 | 25 | 15 | 10 |
| Needs Work | 15 | 10 | 5 | 10 | 6 | 4 |

Lower Body Strength Test

Goal: Establish the user's lower body strength

Method: Squat test
Lower body strength test: The user performs as many squats as possible.

Cardio Fitness Test

Goal: Establish the user's cardio fitness level
Method: Jumping jack test. Thus user takes and inputs their resting heart-rate via input device 14, before performing jumping jacks, and their elevated heart-rate afterward. Such measurement can be done manually at the appropriate time, or determined automatically if the user is wearing a heart monitor in communication with the instructional gaming system.

Figuring Body Mass Index

Goal: Determine the body mass ratio of the user operating the instructional gaming system.

Method: The body mass index (BMI) determines a height to mass ratio based on user inputs in the data fields of FIG. 5. The BMI is determined according to the following equation:

BMI=weight(kg)/height(m)

NOTE: Since BMI uses total body weight (i.e., not estimates of fat and lean body mass separately) in the calculation, it does not discriminate between the overfat and the athletic, more muscular body type. Therefore, BMI should ideally be used in conjunction with other body composition assessments (like Circumference Measures)

TABLE 5
BMI Range
BMI Reference Chart

| Weight Category | BMI Range | % Above Normal Weight |
|---|---|---|
| Normal Weight | 19 to 25 | — |
| Overweight | 26 to 30 | 20 to 40 percent |
| Obese | 31 to 35 | 41 to 100 percent |
| Seriously Obese | Over 35 | >100 percent |

Returning to FIG. 2A, the software then recommends to the user in block 32 that the user should work on the area in which they are most deficient. In FIG. 2A, the recommendation is that the user work on “cardio” to address deficiencies of the user in their cardiovascular fitness as measure during the initial evaluation. Such an evaluation may have been made on the grounds of the user input of “Tired” to a query of their perceived exertion level during a relatively easy cardio evaluation routine. Alternatively, the evaluation may be done automatically based on a large difference between the heart rate as measured before and after the cardio fitness (e.g. jumping jacks) test.

In block 34, the user may accept this recommended instructional focus (here, “Cardio”) or select his or her own. These accepted or input focuses are called the following:

Primary Goal (Long Term Goal): Automatically derived from a user's greatest fitness deficiency. While it is set automatically, it can be altered by the user. The Primary Goal generally determines what area is most targeted during the workout. Primary goals in the fitness context may include weight/inches loss, increased upper body strength, increased core body strength, increased lower body strength, increased flexibility, and weight loss.

Secondary Goal/Focus Area (Daily Focus): Set by the user on a workout to workout basis. In the alternative, the instructional gaming software would recommend the daily focus based on personal profile and workout history.

In block 36, the software then peruses its database of knowledge to construct a curriculum that best addresses the deficiencies of the user, based on the level of deficiency in the focus area. It does this in such a way as to minimize the repetition of tasks presented to the user.

For example, in an Instructional Gaming scenario that is centered around fitness, the user might be asked to do sit-ups, squats, push-ups, and flexibility tests. The software might then determine that the user is deficient in sit-ups, which would indicate a general weakness in core body strength. The software would then construct an exercise based curriculum that would help the user strengthen their core body, while at the same time minimizing how many sets of crunches, sit-ups, and leg-lifts they would do in a row. The curriculum is a multi-session workout schedule, with each session formed from an arrangement of multiple workout blocks stored in the database 22 by workout group (e.g. cardio, core, strength, flexibility, etc) and fitness level (e.g. level 1—easy to level 5—hard). These blocks are arranged by the software heuristics operating on processor 18 to form each session. The software does this by keeping track of what exercises were performed previously, and not allowing those exercises to be generated again, so that those areas of the body are not overworked and over-fatigued.

Workouts preferably include five minutes of both warm-up and cool-down. Whenever a workout includes both cardio and strength elements then the cardio portion should occur before the strength portion. Additionally, there are minimum preferred durations for each focus area:
Cardio
   Min Duration: 30 minutes per workout
      Unless also doing compound, then 20 minutes minimum
   Preferred Duration: 30 minute sessions 3 times a week
   Preferred for Weight Loss: 4-5 times per week, 45-60 minute workout durations
      Unless compound is included then Min Duration: 20 minutes
Strength/Compound
   Min Duration: 10 minutes

FIG. 6 illustrates the construction of workout sessions to form curriculums. Each workout session occurs along a workout timeline 70. Each session further includes a warm-up block at the beginning of the workout time period and a cool-down block at the end of the workout time period, each lasting for a preferred five minutes. The middle portion is termed the body of the workout. The substance of the workout body is divided among the various fitness block types. In the table shown in FIG. 6, for instance, a “weight loss” long term goal with an upper/lower daily focus would result in an arrangement of workout blocks in the following percentages: cardio 70%, compound 10%, upper 5%, core 10%, lower 5%, and flexibility 0%. That is, 70% of the blocks, or in the alternative 70% of the time comprising the workout, is chosen from the cardio database (element 64 in FIG. 9).

The table in FIG. 6 is just an example of how instructional gaming sessions are constructed. The percentage composition of a workout session can change depending upon the amount of time dedicated to each session. It is recognized by fitness professionals, for instance, that no benefit is received from extremely short dedication to certain focuses. For instance, the percentages described above for the composition of a weight-loss session with an upper/lower focus includes 5% of the workout taken from upper and 5% from lower workout blocks. These percentages may be valid for a 45-60 minute workout, but not valid for a short 15-30 minute workout. Instead, the 15-30 minute workout may only include 2 minute warm-up and cool-down periods, and the workout blocks percentage may be arranged in the following ratio: cardio 70%, compound 30%.

Workout sessions are arranged, in a preferred implementation of the invention, to achieve total fitness of the user. Accordingly, the curriculum would be generated that includes multiple types of session types—that is sessions with different daily focuses—so that different parts of the body are worked at different times. Again, these session types may be manually selected by the user at the beginning of the workout session, or planned in advance along a curriculum timeline by the instructional gaming software.

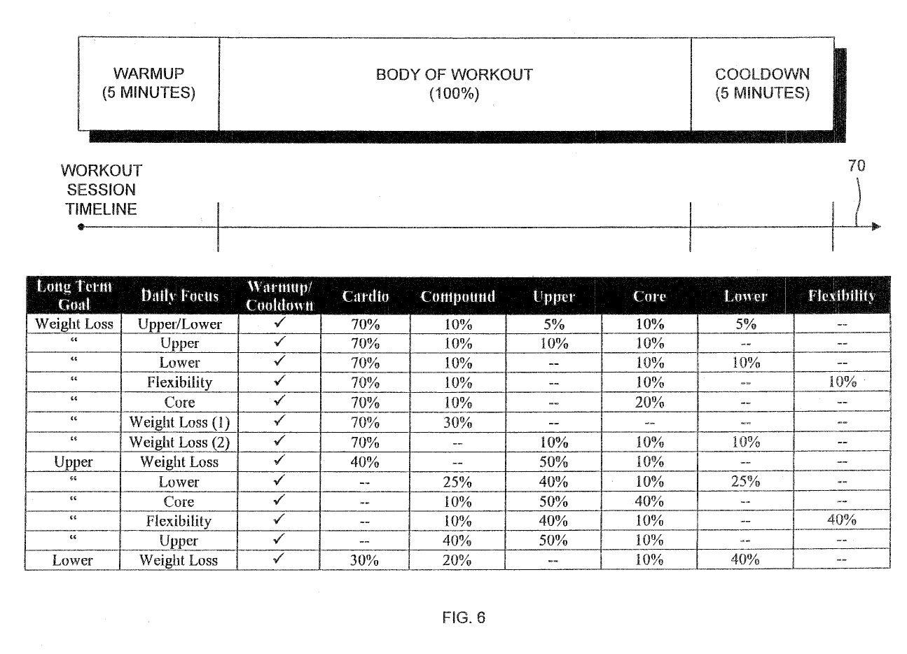

The user then performs the generated session of the curriculum in block 38 (FIG. 2A). FIG. 7 illustrates a workout tutorial in which a dummy model is used to show the proper position for a particular exercise. In the workout generated above, after doing a few sets of sit-ups, and then a few sets of crunches, the user may do some work on their obliques before the software determines that it is OK to do sit-ups again. The software keeps track of the exercise history within some time frame and disallows the same exercises to be generated too close to each other.

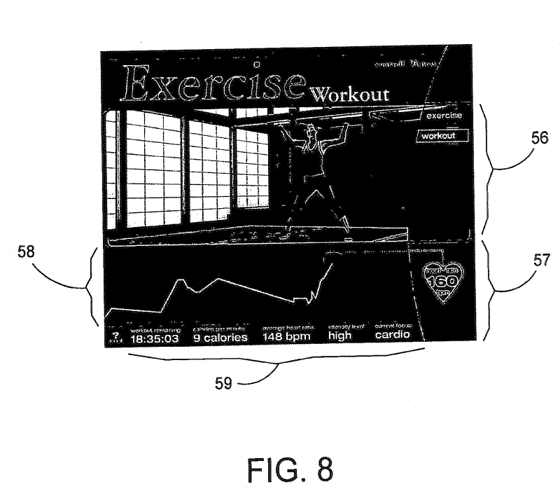

FIG. 8 shows a screen image user interface including an instructor window 56 in which the computer generated character is displayed in the generated environment (here a dojo). If the user is wearing a real-time heart rate monitor, the beats per minute (bpm) measurement is displayed in window 57 with the historical bpm shown along a timeline in window 58. Finally, the screen image shows an informational window 59 listing is time remaining in the workout session, the amount of calories burned, the average heart rate, the current intensity level of the exercise, and the current focus.

At the end of the block, session, and/or curriculum the user is asked about their perceived level of difficulty in completing the tasks in block 40. The feedback that the user gives is folded back into the software to adjust the level of difficulty for a similar curriculum in the future. This input 38-to-curriculum generation 36-to-curriculum work 38-to-input loop 38 is done repeatedly until the user reaches their goals.

The development of a curriculum is based primarily upon two factors:
1. The user's chosen area of focus; and
2. The user's proficiency in the focus areas.

When building a curriculum, a preferred implementation of the instructional gaming would include tasks in the chosen focus area, but which tasks are chosen depends on the user's proficiency. The software would also construct a curriculum that includes tasks in other areas (again only those appropriate to the user's proficiencies), but the bulk of the curriculum will be toward the chosen focus area. Generation of the curriculum is exemplified in two different instructional examples: (1) Fitness shown in FIG. 2A, and (2) Learning a foreign language (French) shown in FIG. 2B. Like block numbers denote like processes.

### Fitness Example:

User chooses to focus on cardio, but cardio fitness is low.
Workouts will consist mainly of low-impact cardio routines, but with a few lower body strength exercises included.

### French Example:

User chooses to focus on vocabulary, and already knows a large number of words.
Classes will consist of more obscure words, but will also have some listening comprehension tasks.

Next, the user performs the generated curriculum. After each of the focus areas are completed (the primary focus area chosen by the user as well as other focus areas that might have been included), the program will gather user feedback to further modify the curriculum. Since the chosen focus area has not changed, this only impacts the second factor in determining the curriculum: i.e. user proficiency.

### Fitness Example:

After a low-impact cardio workout, the program asks the user how difficult the last section was.
Possible answers:
   “I couldn't keep up!”
   “I was proud that I could keep up.”
   “Piece of cake!”

### French Example:

After a more rigorous vocabulary lesson, the program asks the user how well they feel like they know the words.
Possible answers:
   “That went right over my head.”
   “I think I remember most of the words.”
   “I know this stuff like the back of my hand.”
      The next time a curriculum is generated, it will be adjusted based upon the feedback gathered in the last session. If the user expressed ease in performing the given tasks, more difficult tasks will be chosen. Similarly, expressing difficulty results in easier tasks being chosen.

### Fitness Example:

User chooses “Piece of cake!” when asked about cardio, but chose “I couldn't keep up!” for the lower body strength exercises.
The next workout will have somewhat higher impact cardio exercises (e.g. level 4 and 5 if level 3 was deemed “Piece of cake” by user), but less intense lower body exercises (e.g. level 1 and 2 if level 3 was deemed “I couldn't keep up” by user).

### French Example:

User chooses “I know this stuff like the back of my hand” for the vocabulary section, but chose “That went right over my head” for the listening comprehension work.
The next class will have even harder words, but simpler listening comprehension tasks.

FIG. 9 shows the arrangement of workout blocks, such as level 2 cardio block 60 and level 3 lower body strength block 62, into a workout session. Each of the blocks are stored in database 22 and retrieved by the software program from a database of blocks grouped by type. In the example shown in FIG. 9, the types of blocks shown are the cardio database 64, the core strength database 66, and the lower body strength database 68. These databases are not exclusive as other types of exercises are possible such as upper body work, flexibility, speed training, etc. Furthermore, there may be different types of each similar block—say, for instance, 5 types of level 1 cardio blocks, 6 types of level 2 blocks, etc. so that the workout session constructed from such blocks does not become so repetitive.

Each of these blocks, in a preferred embodiment, include computer instructions sufficient to animate a computer generated avatar to instruct on the types of exercises to be performed. Thus, like a workout tape, the user follows the person shown on the display. The computer generated avatar is, in the preferred embodiment, formed of a high quality wire frame and skinned as is well known in the computer graphics arts. Motion capture technology, also well known, would be used to capture and then store vector joint movements of a real person performing portions of the exercise blocks (e.g. a grapevine side-to-side movement, or a warrior Yoga asana). These motion capture data are strung together within each of the workout blocks to form a string of computer instructions, said instructions being stored in the database, and used to drive the avatar to move in lifelike ways during a lesson.

In a typical example of a user of the invention, a user wants to focus on weight loss (which means cardio exercises), and has some interest in lower body strength improvement as well. The user has moderate proficiency in both cardio fitness and lower body strength, but has poor core body strength as tested during the initial evaluation 30.

The workout routine is created and is performed along a timeline 70. After a warm-up period in block 72, the software routine creation algorithm selects cardio exercises of moderate difficulty (mostly difficulty 3, but some 2 and 4 for variety). These cardio exercises are chosen for the first part of the workout. Next, heuristics within the software indicate that the program should include a bit of core body strength work to improve the user's deficiency in this area. Finally, the program includes a few lower body exercises.

As a second pass on the workout, the software engine determines if the animations associated with the given exercises can flow together on their own, or if they require explicit transitions. A database 74 of such transitions is stored in database 22. Data associated with each block indicates the start and finish position. In one example, the warm-up block 72 ends in a kneeling position but the cardio animations (and in particular cardio block 60) start from a standing position. Accordingly, transition animation 76 is chosen that provides fluid movement instructions to the CG instructor displayed on display 12 to move from a kneeling position to a standing position. Furthermore, the program recognizes that a second transition is needed to animate the CG character between the standing cardio 4 position from the end of workout block 78 to a sitting position at the beginning of level 1 core workout block 80. The appropriate transition block 82 is then selected from transition database 74 to effect a smooth visual transition between a standing CG avatar and a sitting one. The program further recognizes that a third animation 84 is necessary to transition between core block 80 (sitting) and lower body level 3 workout block 86 (standing) and inserts the appropriate block within the routine timeline 70.

Users customize their workouts by selecting a focus area (weight loss, Lower body, core, Upper body, Cardio, Flexibility) and the game assembles a workout that integrates their daily desired focus area with their overall fitness goals. This combination of daily change of focus keeps the workout interesting, while the integration with the long-term goal assures that the desired results are achieved.

The Trainer character will react to the user's performance as captured either through the heart-rate monitor and/or through Rating of Perceived Exertion (RPE)
Encouraging the user when she is underperforming
Congratulating the user when she successfully completes workout segments
Workout pace will change according to user performance as measured by RPE
Comparing to previous workouts and saying better or worse in terms of average RPE and peak RPE

An Example of the user interface is described below with reference to a CG Avatar for the fitness instructional gaming example called “Maya”.

### EXAMPLE

“What three words describe you best today?” Maya asks.

The words “Energy Level” appear in field center screen. Arrows above and below the word indicate that you can use the thumb-stick or directional pad on the X-Box controller to let Maya know how you're feeling today. You cycle down through your options . . . “Energized”, “Lively”, “Brisk”, “Frazzled”, “Sluggish.” You settle on “Lively.” Since you've been on Maya's plan you've actually become more energetic. The Energy Level field slides to screen left as another field appears in the center of the screen labeled “Stress.” You blow by the “Frantic” option and happily select the phrase “No Worries” to represent your stress level today. TGIF! The “Stress” field slides to screen right. The third and last field appears center screen and you scroll through the options. Maya wants to know your mood. “Happy.”

The daily focus menu comes up and the daily focus cycles through your options . . . . Lower Body Strength, Core Body Strength, Upper Body Strength . . . . Maya selects Upper Body Strength from the choices. Maya's right, you're still a little sore from Monday's Lower Body workout. You agree with the choice and select Upper Body Strength by pressing the A button.

There are six categories in which a user may set their goals: Upper body strength, Core body strength, Lower body strength, Weight loss, Improved Cardio Vascular fitness, and Flexibility.

As a user builds their profile they are asked to complete a preliminary fitness evaluation which measures their aptitude in each of these areas. The results are used to rank a user's deficiencies. Based on the user's greatest deficiency, Maya will recommend a “Long term goal.” The user is free to accept her recommendation or disregard it in favor of a long term goal of their liking. Whatever their choice, the long term goal may be presented before each workout along with an option for the user to manually or have Maya recommend a “Daily Focus.” This option allows the user to define the focus of each particular workout without altering the percentage of time dedicated to the long term goal may be adjusted if the current workout was scheduled to cover only the long term focus area.

Goals will not generally be time based, only achievement based.

We will use periodic physical challenges (blocks 30 in FIGS. 2A and 2B) to track a user's “hard progress”—or improvement as demonstrated by a quantifiable change in the user's performance of focus isolating motions. Short term progress will be measured by the system with more frequent “feel question” checks. Maya will provide no specific timeline for goal achievement, but can show progress and refocus a user's program to meet their changing needs in the short term.

Maya guides users through a fitness evaluation once as they are building their personal profile, then again after every 10^{th} workout through the physical challenge. The results of fitness evaluations and physical challenges are quantities that demonstrate user progress in a concrete manner.

Feel questions are how Maya determines how a user feels, how effective past workouts have been, and how the structure of future workouts may be modified for maximum effect. Feel questions asked in-workout will require user to input RPE or “Rating of Perceived Exertion.” As a client is exercising, a personal trainer will sometimes ask them to rate their level of exertion. The rating allows the trainer to get a better sense of how hard the client is working.

Maya will ask feel questions before each workout begins and mid-workout (during recovery periods). She will also ask feel questions to determine a user's level of satisfaction with their progress/level of achievement.

RPE is the most important factor in determining an exercise's intensity.

Where a real trainer may ask a client to rate their exertion on a numeric scale, Maya will ask a user to select from three or more phrases which reflect various levels of exertion. Maya will check a user's RPE multiple times during the course of a workout.

Pre-workout check: Occur between the point in time that a user begins a session, and begins their workout. The purpose of this check is to determine the physical and emotional state of the user.
Objective: Determine the user's energy level
Question: “How are you?”
Options: Three phrases showing different energy levels.

| User Options | Modify | Trigger | Effect |
|---|---|---|---|
| Exhausted | Maya's emotional | Dialogue: Energy R1 | |
| | frame to | | |
| Ok | Maya's emotional | Dialogue: Energy R2 | |
| | frame to | | |
| Energized | Maya's emotional | Dialogue: Energy R3 | |
| | frame to | | |

Mid-workout check: Occurs at the end of each general focus area segment during the recovery period. This check is designed to help Maya better understand a user's exertion level per focus area, and general state.
Objective: Determine difficult of last focus area
Question: “How'd that feel?”
Options: Five words or words and icons showing different intensity levels.

| User Options | Modify | Trigger | Effect |
|---|---|---|---|
| Piece of cake! | Maya's emotional | Dialogue: Intensity | |
| | frame to | R1 | |
| Comfortable | Maya's emotional | Dialogue: Intensity | |
| | frame to | R2 | |
| I couldn't keep up | Maya's emotional | Dialogue: Intensity | |
| | frame to | R3 | |

A Virtual Personal Trainer will help the user establish, measure, and achieve their health and fitness goals by providing a fitness and diet regimen and coaching the user through each workout from start to finish. Staying true to the definition of ‘Fitness Gaming,’ Maya (the virtual trainer) motivates users to achieve their fitness goals by first offering them (overt) visible in-game rewards during the initial stages of their program (where they are least likely to actually notice physical progress) such as new workout environments, new music, etc. Then as the user's progress becomes more substantial, Maya rewards users by acknowledging their progress . . . building their sense of personal achievement.

### The 5-Block Method

The body of each workout, in an alternate implementation of the invention, will be divided into 5 distinct segments called “blocks” in addition to warm-up and cool-down segments. There may be more or less blocks without departing from the spirit of the invention. Each block represents 20 percent of a workout. This easy to grasp graphical device will help users more easily understand the composition of their workouts.

TABLE 6
5-Block Workout Session (general)

| | Body of Workout | | | | | |
|---|---|---|---|---|---|---|
| Warm-up | Block 1 | Block 2 | Block 3 | Block 4 | Block 5 | Cool-down |

Users with profiles will be presented with this device during the workout preferences screen. As they select their focus area (Secondary Goal) this chart will automatically update showing the user how much of their workout is allotted to which focus area. For example, a workout built around a Primary Goal of weight loss and a Secondary Goal of upper body strength may look something like this:

TABLE 7
Sample Workout
Sample Workout

| | |
|---|---|
| Warm-up | Warm-up |
| Jog in place | |
| Jumping jacks | |
| Knee-up | |
| Karate Kicks | Cardio: (60%) |
| Squats | |
| Heel/Jack Double | |
| Push Up - Straight Leg | Strength - Upper Body: (40%) |
| Chest Fly - Hand Weights | |
| Cool-down | Cool-down |

The sample workout would be broken into 5 blocks according to a user's focus area . . . with 3 blocks (60%) being devoted to cardio and 2 blocks (40%) devoted to upper body strength work.

TABLE 8
5-Block Workout Session (populated)

| | Body of Workout | | | | | |
|---|---|---|---|---|---|---|
| Warm-up | Cardio | Cardio | Cardio | Upper | Upper | Cool-down |

The preferred implementation of the instructional gaming concept herein described offers several key benefits over prior art instructional systems.

The first benefit is one of generating dynamic content. Workouts (in the fitness context) are generated according to a user's specific fitness needs and goals. The instructional gaming program will create a custom fitness program unique to each user. And because of the flexibility allowed in a real-time 3D game environment; camera angles, workout settings, music, and even the Trainer's appearance can vary from day to day.

The second benefit is one of allowing a fully interactive system. Users are able to input their current fitness levels as well as their fitness aspirations. The instructional gaming system then generates a program which is tailored to that user's particular fitness level. This is not a ‘one size fits all’ approach.

Finally, such a system is responsive to the specific user. The instructional gaming system comes alive with its ability to collect data from a user in the form of vital statistics (age, height, weight, etc. . . . ), dietary information, and through peripherals such as a heart-rate monitor. By tracking a user's perceived exertion level after each workout, the system is able to give users a tangible sense of progress by graphing their performance over time. Additionally, the ability to monitor a user's heart-rate allows the system to measure the effectiveness of cardio fitness. By tracking a user's heart-rate, the Trainer is able to alter the course and difficulty of a workout as it progresses.

Having described and illustrated the principles of the invention in a preferred embodiment thereof, it should be apparent that the invention could be modified in arrangement and detail without departing from such principles. We claim all modifications and variation coming within the spirit and scope of the following claims.

1. A computer readable medium encoded with instructions that, if executed, result in:
eliciting a user to perform a plurality of physical tests;
analyzing the test results to rate different performance areas including at least cardiovascular performance and muscular performance;
accessing a database of exercises, wherein the exercises in the database indicate associated difficulty levels, and wherein the exercises are mapped to the different performance areas so that each difficulty level relates to a respective one of the ratings;
comparing the ratings to the difficulty levels, respectively, and identifying a subset of the exercises according to the comparison; and
dynamically generating a workout session from the subset of exercises, wherein an end segment of the workout session is formed by selecting a combination of exercises from the subset at a time occurring after a beginning segment of the workout session has been completed, and wherein the computer readable medium elicits feedback from the user during the workout session and dynamically modifies the subset during the workout session by adding or deleting exercises to or from the subset according to the solicited feedback.

2. The computer readable medium of claim 29, wherein the instructions, if executed, further result in:
eliciting and obtaining new test results at each occurrence of a first interval;
generating a new subset whenever new tests results are obtained if the new test results vary from previous test results, wherein the new subset of exercises is formed independently of feedback obtained prior to obtaining the associated new test results; and
continuing to elicit feedback from the user according to a second interval after generating the new subset of the exercises, wherein the second interval is more frequent than the first interval, and wherein the new subset is dynamically modified by adding or deleting exercises to or from the new subset according to the continually elicited feedback.

3. The computer readable medium of claim 29, wherein the instructions, if executed, further result in:
graphically rendering a model that performs the exercises selected in the workout session to guide the user through the workout session.

4. The computer readable medium of claim 31, wherein at least one combination of the exercises performed by the model is rendered during the workout session, and wherein the graphical rendering of the at least one combination of exercises is not pre-rendered.

5. The computer readable medium of claim 29, wherein the instructions, if executed, further result in:
identifying a duration of the workout session;
determining a duration of a warm-up period according to the identified workout session duration; and
selecting a combination of exercises from the subset to fit within the determined duration.

6. The computer readable medium of claim 33, wherein the instructions, if executed, further result in:
filtering the subset according to information from the database indicating which exercises are associated with the warm-up period; and
selecting the combination of exercises to fit within the determined duration from the filtered subset.

7. The computer readable medium of claim 29, wherein the instructions, if executed, further result in:
comparing the ratings to identify a most deficient one of the performance areas;
setting an inter-session workout goal according to the identified deficient performance area;
identifying an intra-session workout goal according to an input indicating a user's preference for the workout session;
identifying a duration of the workout session; and
allocating a first portion of the workout session to the inter-session workout goal and a second portion of the workout session according to the intra-session workout goal, wherein durations of the first and second portions are determined according to the identified workout session duration.

8. The computer readable medium of claim 35, wherein the instructions, if executed, further result in:
utilizing the performance area mappings to select, for the first portion, exercises from the subset that correspond to the inter-session workout goal; and
utilizing the performance area mappings to select, for the second portion, exercises from the subset that correspond to the intra-session workout goal.

9. The computer readable medium of claim 29, wherein the instructions, if executed, further result in:
obtaining the feedback by querying the user.

10. The computer readable medium of claim 37, wherein the instructions, if executed, further result in:
obtaining the feedback by measuring a user's biological response to a completed portion of the workout session.

11. A computer readable medium encoded with instructions that, if executed, result in:
eliciting a user to perform a plurality of physical tests;
analyzing the test results to obtain performance ratings;
comparing the ratings to a database containing a plurality of entries, wherein each entry includes an exercise and an associated difficulty level for that exercise;
initially filtering the exercises according to the comparison to generate an initial list of exercises;
dynamically generating a workout session from the initial list, wherein an end segment of the workout session is formed by selecting a combination of exercises at a time occurring after a beginning segment of the workout session has been completed;
eliciting feedback from the user during the workout session and dynamically forming new lists during the workout session by adding or deleting exercises from the initial list according to the elicited feedback, wherein the computer readable medium dynamically generates the workout session by assembling exercise combinations using the most recently formed list.

12. The computer readable medium of claim 39, wherein the instructions, if executed, further result in:
obtaining the feedback by querying the user.

13. The computer readable medium of claim 40, wherein the instructions, if executed, further result in:
obtaining the feedback by measuring a user's biological response to a completed portion of the workout session.

14. The computer readable medium of claim 39, wherein the instructions, if executed, further result in:
graphically rendering a model that performs the exercises selected in the workout session to guide the user through the workout session.

15. The computer readable medium of claim 42, wherein at least one combination of exercises performed by the model is rendered during the workout session, and wherein the graphical rendering of the at least one combination of exercises is not pre-rendered.

16. An apparatus, comprising:
a display; and
circuitry coupled to the display, the circuitry configured to:
display graphical representations of a plurality of physical tests and eliciting a user to perform the physical tests according to the displayed graphical representation of the tests;
obtain performance results after the user completes the physical tests;
compare the obtained performance results to a database containing a plurality of entries, wherein each entry includes an exercise and an associated difficulty level for that exercise;
initially filter the exercises according to the comparison to generate an initial list of the exercises;
dynamically generate a workout session from the initial list, wherein an end segment of the workout session is formed by selecting a combination of exercises at a time occurring after a beginning segment of the workout session has been completed; and
obtain feedback from the user during the workout session and dynamically form new lists during the workout session by adding or deleting exercises from the initial list according to the obtained feedback, wherein the workout session is dynamically generated by assembling exercise combinations using the most recently formed list.

17. The apparatus of claim 44, wherein the circuitry is further configured to obtain the feedback by querying the user.

18. The apparatus of claim 45, wherein the circuitry is further configured to obtain the feedback by measuring a user's biological response to a completed portion of the workout session.

19. The apparatus of claim 44, wherein the circuitry is further configured to graphically render a model that performs the exercises selected in the workout session to guide the user through the workout session.

20. The apparatus of claim 47, wherein at least one combination of exercises performed by the model is rendered during the workout session, and wherein the graphical rendering of the at least one combination of exercises is not pre-rendered.
